(19) United States
(12) Patent Application Publication
(10) Pub. No.: US 2025/0198041 A1
(43) Pub. Date: Jun. 19, 2025

(54) CONTROLLED PH RINSE TO LIMIT CROSS-CONTAMINATION IN ELECTROPLATING BATHS

(71) Applicant: APPLIED Materials, Inc., Santa Clara, CA (US)

(72) Inventors: Eric Bergman, Kalispell, MT (US); John L. Klocke, Kalispell, MT (US); Charles Sharbono, Whitefish, MT (US)

(73) Assignee: APPLIED Materials, Inc., Santa Clara, CA (US)

(21) Appl. No.: 18/542,158

(22) Filed: Dec. 15, 2023

(51) Int. Cl. C25D 21/08; B01F 23/451; B01F 101/24

(52) U.S. Cl. CPC C25D 21/08; B01F 23/451; B01F 2101/24

(57) ABSTRACT

A method of reducing cross-contamination on a wafer, the method including removing the wafer from an electroplating solution, rinsing the wafer with an acid, wherein the acid contacts residual electroplating solution on the wafer and forms a rinsate, and removing the rinsate from the wafer. Further, a method of removing cross-contamination on a wafer, the method including rinsing the wafer with a methane sulfonic acid (MSA) mixture, where the MSA mixture contacts residual electroplating solution on the wafer and forms a rinsate and removing the rinsate from the wafer.

### BACKGROUND

Microelectronic devices are generally formed on a semiconductor wafer or other type of substrate or workpiece. In a typical manufacturing process, one or more thin metal layers are formed on a wafer to produce microelectronic devices and/or to provide conducting lines between devices.

The metal layers are generally applied to the wafers via electrochemical plating in an electroplating processor (also referred to as an electroplating apparatus). A typical electroplating processor includes a vessel for holding an electrolyte or electroplating solution, one or more anodes in the vessel in contact with the electroplating solution, and a head having a contact ring with multiple electrical contact fingers that touch the wafer. The electrically conductive surface of the workpiece is immersed in the electroplating solution such as a bath of liquid electrolyte and an electrical contact causes metal ions in the electroplating solution to plate out onto the wafer, forming a metal layer or film. An electrical connection to the electrically conductive surface of the wafer may be made within an edge exclusion zone which is typically under 3 mm in width around the circumference of the wafer. Generally, multiple electroplating processors are provided within an enclosure, along with other types of processors, to form an electroplating system.

Multiple electroplating operations with multiple electroplating solutions and rinse chemistries such as deionized water may problematically lead to cross-contamination of copper plating baths, which can cause cross-contamination to a wafer.

The inventors have further observed that plate-up on the seal and/or electrical contacts on a contact ring require frequent maintenance for cleaning and/or de-plating. The continuous need to maintain the contacts and the seal problematically reduces the throughput or use efficiency of the electroplating processor, as the electroplating processor is idle during the cleaning procedures. Tin and/or silver (SnAg) cross-contamination in copper (Cu) plating baths is a major problem in wafer processing. Additional hardware in the electroplating system, such as seals, provide an additional vector where cross-contamination may occur.

Therefore, methods of preventing or reducing cross-contamination are needed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Methods and apparatus for reducing or eliminating the formation of conductive deposits on surfaces in electrochemical plating equipment are provided herein. In some embodiments, a method of reducing cross-contamination in semiconductor electrochemical plating equipment, a surface thereof, and/or a wafer during electrochemical plating includes removing the wafer from an electroplating solution; rinsing the wafer with an acid, where the acid contacts a residual electroplating solution on the wafer and forms a rinsate, and removing the rinsate from the wafer.

In some embodiments, the acid has a pH ranging from about 0 to about 5.5. In some embodiments, the acid has a pH of 4 or lower. In some embodiments, the acid has a pH of 2 or lower. In some embodiments, the acid includes carbonic acid. In some embodiments, the acid includes methane sulfonic acid (MSA).

In some embodiments, the method further includes mixing acid precursors before rinsing the wafer. In some embodiments, mixing the acid includes using a static mixer to mix the acid precursors in a separate container. In some embodiments, mixing the acid includes directing the acid precursors through a rinse line of a length sufficient to mix the acid precursors into a homogenous acid. In some embodiments, mixing the acid precursors includes injection mixing the acid precursors.

In some embodiments, the acid is applied under conditions sufficient to prevent precipitation of organometallic or metallic precursors.

In another aspect, disclosed herein is a method of removing cross-contamination on a wafer, the method including rinsing the wafer with a methane sulfonic acid (MSA) mixture, where the MSA mixture contacts residual electroplating solution on the wafer and forms a rinsate, and removing the rinsate from the wafer.

In some embodiments, the method further includes mixing the MSA mixture before rinsing the wafer. In some embodiments, mixing the MSA includes using a static mixer to mix the MSA mixture in a separate container. In some embodiments, mixing the MSA mixture includes directing the MSA mixture through a rinse line of a length sufficient to mix the acid into a homogenous mixture. In some embodiments, mixing the MSA mixture includes injection mixing the MSA mixture.

In some embodiments, the MSA mixture is applied under conditions sufficient to prevent precipitation of organometallic or metallic precursors. In some embodiments, the MSA mixture has a pH ranging from about 0 to about 5.5. In some embodiments, the MSA mixture has a pH of 4 or lower. In some embodiments, the MSA mixture has a pH of 2 or lower.

Other and further embodiments of the present disclosure are described below.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 schematically illustrates a cross-sectional view of an electroplating processor in accordance with the present technology;

FIG. 2 is a perspective view of the contact ring shown in FIG. 1, in accordance with the present technology;

FIG. 3 schematically illustrates a cross-sectional view of an electroplating processor of FIG. 1 processing a wafer, in accordance with the present technology;

FIG. 4 is a schematic illustration of a tool for carrying out processes for forming features described herein, in accordance with the present technology;

FIGS. 5A-5D are process flow diagrams of a method of reducing cross-contamination from a wafer, in accordance with the present technology;

FIG. 6A is an example system for mixing an acid, in accordance with the present technology;

FIG. 6B is another example system for mixing an acid, in accordance with the present technology;

FIG. 6C is yet another example system for mixing an acid, in accordance with the present technology;

FIG. 7 is a method of reducing cross-contamination of a wafer, in accordance with the present technology;

FIG. 8 is another method of reducing cross-contamination of a wafer, in accordance with the present technology;

FIG. 9 is another method of reducing cross-contamination of a wafer, in accordance with the present technology; and

FIG. 10 is a method of reducing cross-contamination of a wafer, in accordance with the present technology.

### DETAILED DESCRIPTION

Disclosed herein are methods of reducing cross-contamination of a wafer and/or additional hardware of an electroplating system. In some embodiments, the hardware and/or the wafer is removed from electroplating solution and rinsed with an acid, as described herein. The acid may interact with residual electroplating solution to form a rinsate and be removed from the wafer and/or hardware of the electroplating system. In this manner, cross-contamination of the electroplating system and/or the wafer may be prevented or at least reduced.

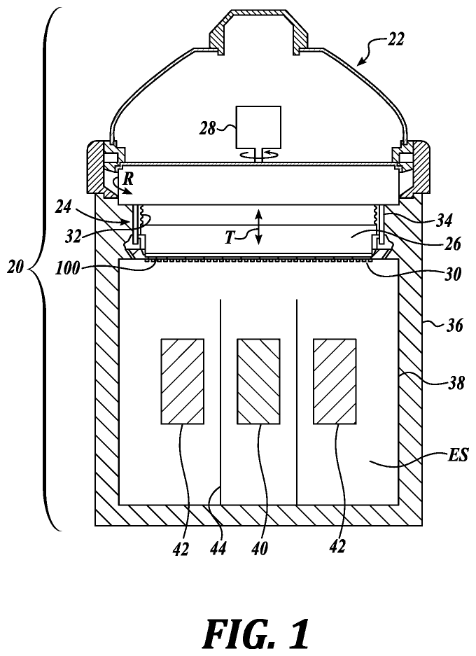

FIG. 1 schematically illustrates a cross-sectional view of an electroplating processor 20 in accordance with the present technology. A non-limiting example of an electroplating processor 20 is shown including a head 22 and a rotor 24. In some embodiments, a motor 28 within head 22 rotates the rotor 24 in a predetermined direction around an axis, as indicated by the arrow R in FIG. 1. In some embodiments, contact ring 30 such as an annular contact ring that is configured on or attachable to the rotor 24 makes electrical contact with a wafer 100 held into or onto the rotor 24. In some embodiments, the rotor 24 may include a backing plate 26 and ring actuators 34 for moving the contact ring 30 vertically (in the direction T in FIG. 1) between a wafer load/unload position and a processing position. In some embodiments, the head 22 may include bellows 32 to allow for vertical or axial movement of the contact ring 30 while sealing off internal head components from process liquids and vapors.

In some embodiments, the head 22 is engaged onto a frame 36. A vessel or bowl 38 within the frame 36 holds electroplating solution ES such as a bath of liquid electrolyte. The bath supply includes a source of metal ion(s) to be deposited on the surface of a workpiece. The metal or metals to be plated onto the workpiece or wafer 100 such as a substrate in accordance with the methods described herein are present in an electroplating solution ES as species of metal ions to be deposited onto the workpiece. In some embodiments, the metal ions are deposited under process conditions that preferentially deposit metal ions into recessed features as opposed to the surrounding flat surfaces. In some embodiments, head 22 is movable to position a wafer 100 held in the rotor 24 into contact with electroplating solution ES such as a bath of liquid electrolyte in the bowl 38.

In some embodiments, one or more electrodes are positioned in the bowl. For example, the bowl may include a center electrode 40 and a single outer electrode 42 that is surrounding and concentric with the center electrode 40. In some embodiments, the center electrode 40 and single outer electrode 42 may be provided in a dielectric material field shaping unit 44 to set up a desired electric field and current flow paths within the electroplating processor 20. Various numbers, types and configurations of electrodes may be used. The electrode is in electrical contact with the electroplating solution ES. The power supply provides electroplating potential between the surface of the workpiece and the electrode which promotes the electroplating of electroplate metal ions onto the surface. The controller controls the supply of electroplating power so that the metal ions are deposited on the workpiece surface.

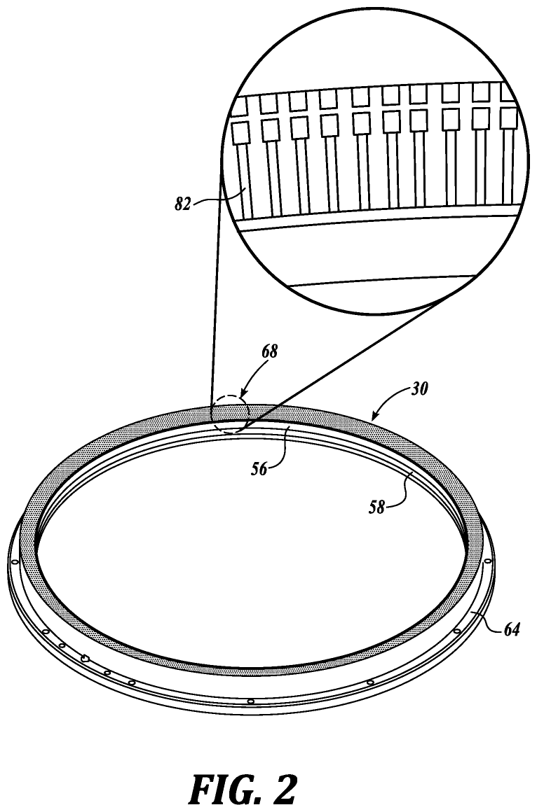

FIG. 2 is a perspective view of the contact ring shown in FIG. 1, in accordance with the present technology. Referring now to FIG. 2, a contact ring 30 is shown separated from the rotor 24 and inverted. Accordingly, the contact fingers collectively referenced as 82 on the contact ring 30, which are shown at or near the top of the contact ring 30 in FIG. 2, are at or near the bottom end of the contact ring 30 when the contact ring 30 is installed into the rotor 24. A mounting flange 64 may be provided on the contact ring for attaching the contact ring 30 to the rotor 24 with fasteners. In some embodiments, contact fingers 82 may be provided on a straight strip 68. The contact fingers 82 may be flat and rectangular, and equally spaced apart from each other. The contact ring 30 may have 300 to 1000 contact fingers, with typical designs using 360 or 720 contact fingers.

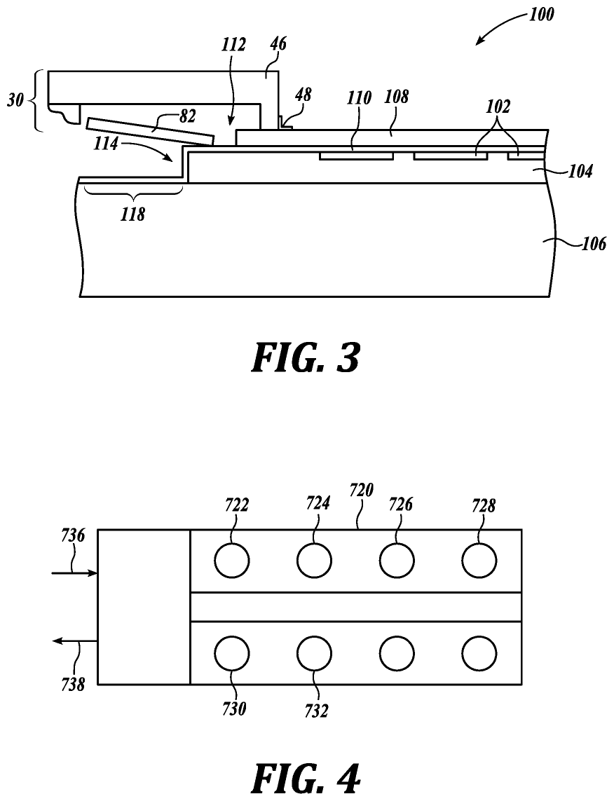

FIG. 3 schematically illustrates a cross-sectional view of the electroplating processor of FIG. 1 while processing a wafer 100, in accordance with the present technology. Referring now to FIG. 3, a schematic cross-sectional side view of a wafer 100 such as a reconstituted wafer having individual dies 102 embedded in a layer of molding compound or epoxy 104 on a glass, plastic, ceramic or substrate 106 such as a silicon substrate is shown. In some embodiments, a photoresist layer 108 is disposed atop and covers a seed layer 110 such as a metal seed layer, except at the edge exclusion zone 112. In some embodiments, the seed layer 110 is applied onto the sidewall or bevel at the edge of the molding compound or epoxy 104 and onto the edge of the substrate 106, forming a seed layer step generally shown at 114.

Still referring to FIG. 3, a contact finger 82 is shown contacting the seed layer 110 at the edge exclusion zone 112, which is located above the layer of molding compound or epoxy 104 and radially outside of the photoresist layer 108. In some embodiments, the contact ring 30 includes a seal 46 such as an annular seal overlying the contact fingers and configured to prevent the electroplating solution such as from a bath of electrolyte from contacting the contact fingers 82. The seal 46 has an annular sealing surface or edge 48 adapted to seal against a wafer 100, or, in some embodiments as shown in FIG. 3, adapted to seal against the photoresist layer 108 on the wafer 100, and with all contact fingers 82 radially outside of the annular sealing surface 48. In some embodiments, the methods of the present disclosure prevent insoluble deposits from forming on seal 46 and surfaces thereof such as edge 48, and other surfaces that contact both the electroplating solution such as from a bath of electrolyte and acid in accordance with the present disclosure. In some embodiments, the methods of the present disclosure prevent cross-contamination from the wafer 100 to the seal 46 and surfaces thereof such as edge 48. In some embodiments, the prevention of cross-contamination also maintains the life of the seal 46 such that electroplating solution from a bath of electrolyte does not contact fingers 82 over the life of the seal 46. In some embodiments, methods of the present disclosure prevent buildup and cross-contamination on the wafer 100.

Still referring to FIG. 3, the width of the edge exclusion zone 112 (on top of the step 114) is influenced by the positioning and concentricity of the photoresist layer 108 and the molding compound or epoxy 104 and may vary by the type of wafer 100 or reconstituted wafer involved. Generally, the edge exclusion zone is up to 3.0 mm wide but other values are also possible. The seed layer extension 118 on the substrate 106 radially outside of the layer of molding compound or epoxy 104, shown in dotted lines in FIG. 3, is a contingent landing area, because the seed layer 110 may not maintain continuity over the step 114. During electro-processing a wafer having an electrically conductive edge exclusion zone 112 may be placed into an electroplating processor having a contact ring having a plurality of contact fingers. A front side of the wafer may be moved into engagement with one or more contact fingers, with the contact fingers contacting the front side of the wafer in the edge exclusion zone, and the front side of the wafer may be placed into contact with an electroplating solution or electrolyte. Electric current may be conducted through the electroplating solution, the edge exclusion zone and one or more contact fingers. Metal ions in the electrolyte deposit out onto the conductive edge exclusion zone and other areas electrically connected to the conductive edge exclusion zone, forming a metal layer on the wafer.

In some embodiments, after the metal is deposited, the electrochemical plating equipment or one or more surfaces thereof, such as those shown in wafer 100, are removed from the electroplating solution and are rinsed by contacting with an acid (also referred to herein as a rinse agent) having a pH similar to the pH of the electroplating solution. By using acid with a preselected pH, embodiments of the present disclosure maintain contaminants in solution in the rinsate or mixture formed including the acid and any residual electroplating solution disposed atop the seal 46 and/or the wafer 100. In some embodiments, the pH of the residual electroplating solution can be measured according to known techniques, such as using a pH meter in a 20-degree Celsius solution, to obtain a first pH value, and the pH of the acid may be predetermined or measured to obtain a second pH value, which may be the same as the first pH value or different. In some embodiments, the pH meter is calibrated as known in the art. In some embodiments, the pH of the residual electroplating solution and pH of the acid may be a value between 2 and 4.5. In some embodiments, the pH of the residual electroplating solution and pH of the acid may be similar such as, for example, within a pH value of plus or minus 2, 1, 0.5, or 0.2 to 2.0. In some embodiments, the pH of the residual electroplating solution may be about 3, and the pH of the acid may be about 5. In some embodiments, the pH of the residual electroplating solution may be about 3.5, and the pH of the acid may be about 3.5 to 4.5. In some embodiments, the pH of the residual electroplating solution may be about 4, and the pH of the acid may be about 4. In some embodiments, the pH of the electroplating solution may be below 1, and the pH of the acid may be about 2 for the purpose of suppressing plate-up.

In some embodiments, the acid has a preselected pH value. For example, the pH of the acid may be equal or similar to the pH of the electroplating solution. Preselecting a pH may include preselecting a type of acid. In some embodiments, the acid is a mineral acid, such as an acid derived from an inorganic compound. Non-limiting examples of suitable mineral acids include hydrogen bromide (BrH), hydrogen iodide (HI), hydrochloric acid (HCl), nitric acid (HNO₃), nitrous acid (HNO₂), phosphoric acid (H₃PO₄), sulfuric acid (H₂SO₄), boric acid (H₃BO₃), hydrofluoric acid (HF), perchloric acid (HClO₄), and combinations thereof. In some embodiments, organic acids such as alkylsulfonic acids, e.g., methane sulfonic acid (MSA) is a suitable acid in accordance with the present disclosure. In some embodiments, organic acids provide pH control as described herein, but also act as chelating agents sufficient for bonding with species in solution which, if not chelated, may promote the formation of plate-up films. In some embodiments, MSA may include 1M MSA, and may be diluted in water in the range of about a 5:1 ratio to about a 50:1 ratio, having a pH range of about a pH of 4 to about a pH of less than 1. In some embodiments, suitable methane sulfonic acid for use herein includes methane sulfonic acid having a molar concentration in the range of 0.02 M to 1M and a pH in the range of <1 to 4.5. In some embodiments, for example where the electroplating solution includes a tin-silver plating bath with a pH of around 3, a 0.04M solution of MSA (also referred to herein as an MSA mixture) with a pH of about 3.5 is sufficient for preventing plate-up after several thousand plating cycles, e.g., greater than 2500 plating cycles.

In some embodiments, the acid comprises or consists of methane sulfonic acid. For example, methane sulfonic acid (pH of about 2 and a concentration of approximately 20 g/L methane sulfonic acid (MSA) in water) may be provided in an amount sufficient to prevent the formation of a precursor layer and/or subsequent plate-up. In one embodiment, methane sulfonic acid is a suitable acid for use in accordance with the present disclosure, wherein the methane sulfonic acid has a concentration of at least 3.6 g/L and solution thereof has a pH of about 3. In some embodiments, the acid mixture such as methane sulfonic acid (MSA) mixture is contacted with a surface in need thereof for 10 seconds or more, or a duration sufficient to displace the bulk of the plating chemistry from the surface being cleaned.

In some embodiments, the acid is an acid solution comprising carbonic acid (H₂CO₃). In embodiments, the rinse agent is applied under conditions sufficient to prevent precipitation of organometallic or metallic precursors from the rinsate. For example, in some embodiments, carbonic acid is applied as an acid, wherein the pH of the acid is similar or somewhat higher than the pH of the electroplating solution or electrolyte. In some embodiments, a carbonic acid rinse agent is formed by dissolving carbon dioxide in water and under pressure to achieve a pH between about 3 and 4. In some embodiments, carbon dioxide may also be injected directly into water to form carbonic acid or may be pressurized on one side of a permeable membrane with water on the other side of the membrane. Such systems are commercially available and are often known as gas contactors. Gas diffuses through the barrier and dissolves in the water, thereby forming carbonic acid. In some embodiments, carbonic acid is provided in amounts sufficient and under conditions suitable for preventing the formation of plate-up precursors and subsequent plate-up. In some embodiments, for example where the electroplating solution includes a tin-silver plating bath with a pH of around 3, a concentration of carbonic acid resulting in a pH of about 3 to 4 is suitable to prevent plate-up when used to rinse the tin-silver plating bath. In some embodiments, a concentration of carbonic acid resulting in a pH of about 3 to 4 is sufficient to prevent plate-up when used to rinse the tin-silver plating bath after several thousand plating cycles, e.g., greater than 3000 plating cycles.

In some embodiments, the acid is electrolyzed water such as cathode water having a pH of 4.5 to 2.7. By using the cathode water at reduced pH to rinse surfaces which have been exposed to electroplating solutions and chemistries, constituents of the electroplating solution and/or plating bath remain in solution and do not deposit on the surfaces, creating the plate-up precursor film and eventual plate-up. In some embodiments, such as with an alkali electroplating solution or bath, anode water may be used in a similar manner. In such embodiments, acid and the electroplating solution may have a substantially similar pH within the range of, e.g., 8-10.

In some embodiments, a pH adjusting agent may be included to obtain a preselected pH of an acid. For example, a pH adjusting agent can be added to an acid of the present disclosure. In some embodiments, pH adjusting agents may be provided in any amount necessary to obtain a desired pH value in the final composition of the acid. Acidic pH adjusting agents can be organic acids, including amino acids, and inorganic mineral acids. Non-limiting examples of acidic pH adjusting agents include acetic acid, citric acid, fumaric acid, glutamic acid, glycolic acid, hydrochloric acid, lactic acid, nitric acid, phosphoric acid, sodium bisulfate, sulfuric acid, and the like, and combinations thereof. In some embodiments, all organic acids are contemplated for use as pH adjusting agents. Non-limiting examples of alkaline pH adjusting agents include alkali metal hydroxides, such as sodium hydroxide, and potassium hydroxide; ammonium hydroxide; organic bases; and alkali metal salts of inorganic acids, such as sodium borate (borax), sodium phosphate, sodium pyrophosphate, and the like, and mixtures thereof.

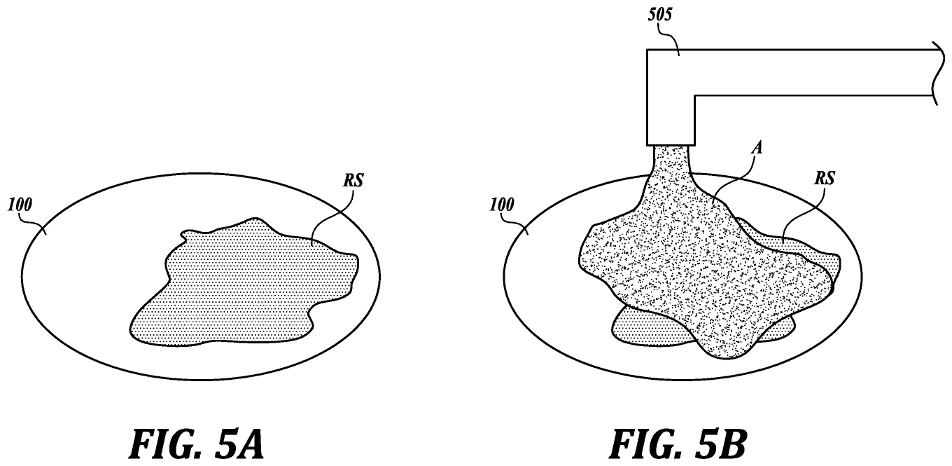

FIG. 4 is a schematic illustration of a tool for carrying out processes for forming features described herein, in accordance with the present technology. Referring now to FIG. 4, and integrated tool 720 can be provided to carry out a number of process steps involved in the formation of microfeatures on wafers. Below is described one possible combination of processing stations that could be embodied in a processing tool platform sold under the trademark RAIDER® by Applied Materials, Inc. of Santa Clara, Calif. Other processing tool platforms could be configured in similar or different manners to carry out metallization steps such as those described below. Referring to FIG. 4, an exemplary integrated processing tool such as tool 720 includes stations to carry out a pre-wet process 722, optional metal deposition such as copper deposition process 724, under bump metallization process 726, rinse process 728, alloy deposition process 730, and a spin-rinse-dry process 732. The chambers for carrying out such process sequences can be arranged in various configurations. Microelectronic workpieces are transferred between the chambers through the use of robotics (not shown). The robotics for the tool 720 are designed to move along a linear track. Alternatively, the robotics can be centrally mounted and designed to rotate to access the input section 736 and the output section 738 of tool 720. Processing tool such as tool 720 is capable of being programmed to implement user entered processing recipes and conditions.

The rinse chamber or station for rinse process 728 and spin-rinse-dry chamber or station for spin-rinse-dry process 732 may include the acid as described herein and can be of the type available from numerous manufacturers for carrying out such process steps. Examples of such chambers include spray processing modules and immersion processing modules available in conjunction with the RAIDER® ECD system. The optional metal such as copper deposition chamber for optional copper deposition process 724, under bump metallization chamber for under bump metallization process 726 and metal alloy deposition chamber alloy for alloy deposition process 730 can be provided by numerous electroplating and electroless deposition chambers such as those available as immersion processing modules and electroplating processing reactors for the RAIDER® ECD system.

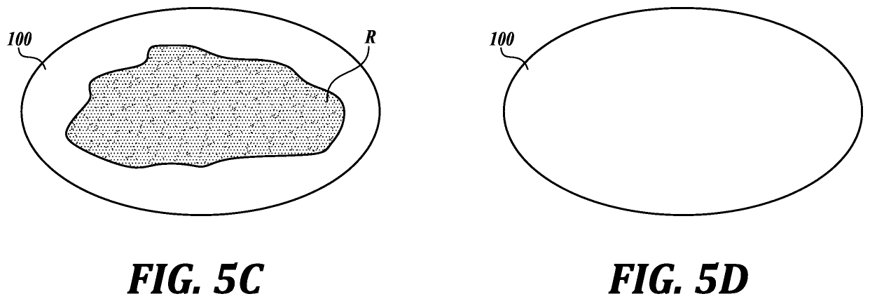

FIGS. 5A-5D are process flow diagrams of a method of reducing cross-contamination from a wafer 100, in accordance with the present technology. As shown in FIGS. 5A-5D, the wafer 100 may be removed from the electroplating processor. In some embodiments, the same method may be performed on a seal (such as seal 46 of FIG. 3). In FIG. 5A, the wafer 100 has residual electroplating solution RS on its surface. One skilled in the art will understand that FIGS. 5A-5D are simplified diagrams, and any amount of residual electroplating solution RS may be present on the wafer 100 (or seal) upon its removal from the electroplating solution.

In FIG. 5B, the wafer 100 is rinsed with an acid (or rinse agent) A. In some embodiments, the acid A is delivered through a rinsate line (or tube) 505. In some embodiments, the acid A is an MSA mixture. In some embodiments, the acid A is carbonic acid. In some embodiments, the acid A has a pH ranging from about 0 to about 5.5. In some embodiments, the acid A has a pH of 4 or lower. In some embodiments, the acid A has a pH of 2 or lower. In FIG. 5C, the residual electroplating solution RS and the acid A mix together to form a rinsate R. In FIG. 5D, the rinsate R is removed from the wafer 100, such as with a tool as shown in FIG. 4.

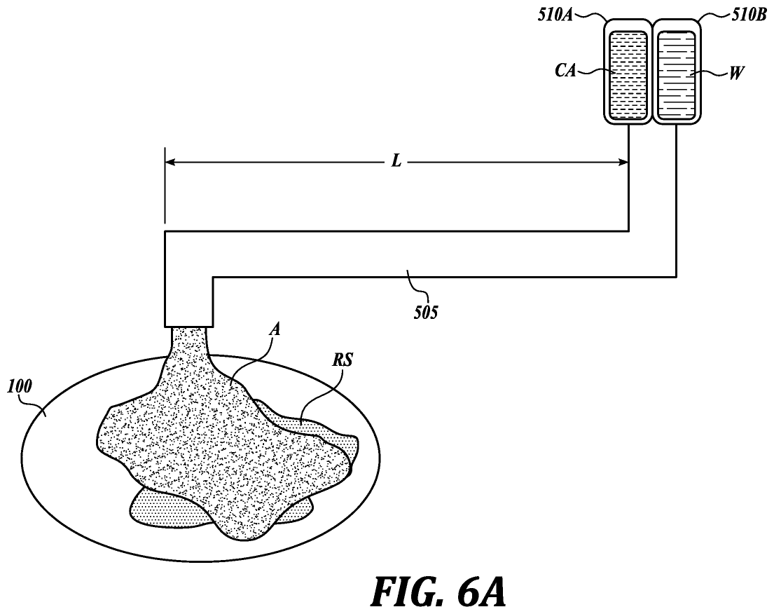

FIG. 6A is an example system for mixing an acid A, in accordance with the present technology. In some embodiments, the acid A may be mixed before it is used to rinse the wafer 100 (or the seal, as described herein). In some embodiments, the mixing system includes at least two reservoirs 510A, 510B. In some embodiments, a first reservoir 510A of the at least two reservoirs 510A, 510B is configured to hold concentrated acid (or acid precursor) CA. In some embodiments, a second reservoir 510B of the at least two reservoirs 510A, 510B is configured to water W. In some embodiments, water W is deionized (DI) water.

In some embodiments, the mixing system mixes the acid precursor CA with water W by directing both acid precursor CA and water W into a rinsate tube 505 having a sufficient length L. In some embodiments, the sufficient length is any length that allows for the acid precursor CA and the water W to mix into a homogeneous acid mixture. In some embodiments, the length L is between about 10 cm and 3 meters.

FIG. 6B is another example system for mixing an acid, in accordance with the present technology. In some embodiments, the acid A may be mixed before it is used to rinse the wafer 100 (or the seal, as described herein). In some embodiments, the mixing system includes at least two reservoirs 510A, 510B. In some embodiments, a first reservoir 510A of the at least two reservoirs 510A, 510B is configured to hold concentrated acid (or acid precursor) CA. In some embodiments, a second reservoir 510B of the at least two reservoirs 510A, 510B is configured to water W. In some embodiments, water W is deionized (DI) water. In some embodiments, the mixing system further includes a rinsate tube 505, a mixing chamber 520, and a static mixer 515.

In operation, acid precursor CA and water W may be mixed in the mixing chamber 520 with a static mixer, before flowing or being directed into the rinsate tube 505. In such embodiments, the acid precursor CA and the water W are mixed by the static mixer 520 to form the homogenous acid A.

FIG. 6C is yet another example system for mixing an acid, in accordance with the present technology. In some embodiments, the acid A may be mixed before it is used to rinse the wafer 100 (or the seal, as described herein). In some embodiments, the mixing system includes at least two reservoirs 510A, 510B. In some embodiments, a first reservoir 510A of the at least two reservoirs 510A, 510B is configured to hold concentrated acid (or acid precursor) CA. In some embodiments, a second reservoir 510B of the at least two reservoirs 510A, 510B is configured to water W. In some embodiments, water W is deionized (DI) water.

In some embodiments, the mixing system further includes one or more injection valves 530A, 530B, each configured to injection mix the acid precursor and/or the water in an injection mixing chamber 525, and a rinsate tube 505. In some embodiments, the injection valves may be configured to injection mix the acid precursor CA and the water W to form a homogenous acid A in the injection mixing chamber 525. The acid A may then flow through the rinsate tube 505 onto the wafer (or seal).

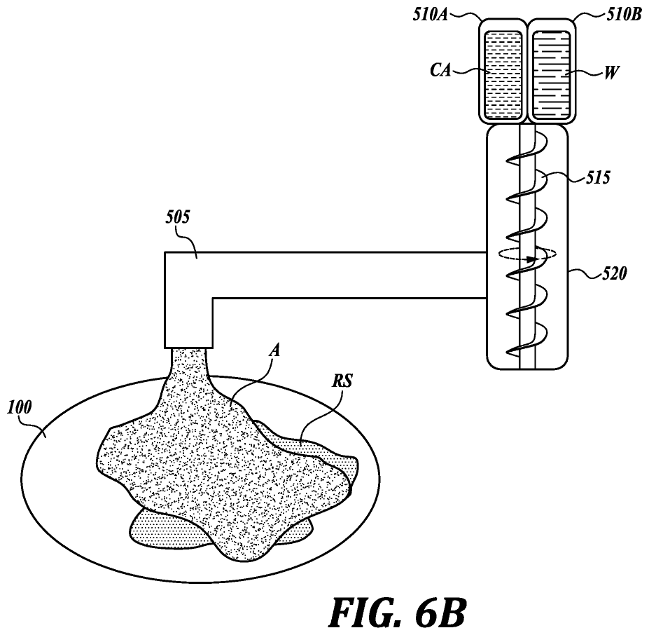

FIG. 7 is a method of reducing cross-contamination of a wafer, in accordance with the present technology. It should be understood that method 700 may be carried out with any of the systems disclosed herein. Furthermore, any of the methods illustrated in FIGS. 7-10 may be carried without all the illustrated steps or with additional steps. In some embodiments, method 700 may include an electroplating processor (such as electroplating processor 50), electroplating solution (such as electroplating solution ES), a wafer (such as wafer 100), a seal (such as seal 46), residual electroplating solution (such as residual electroplating solution RS), an acid (such as acid A), and/or a rinsate (such as rinsate R).

In block 705, the wafer (or seal) is removed from the electroplating solution. In some embodiments, when the wafer is removed from the electroplating solution, residual electroplating solution (such as shown in FIG. 5A) is present on the wafer.

In block 710, the wafer (or seal) is rinsed with acid. In some embodiments, the acid mixes with the residual electroplating solution to form a rinsate. In some embodiments, the pH of the residual electroplating solution and pH of the acid may be a value between 2 and 4.5. In some embodiments, the pH of the residual electroplating solution and pH of the acid may be similar such as, for example, within a pH value of plus or minus 2, 1, 0.5, or 0.2 to 2.0. In some embodiments, the pH of the residual electroplating solution may be about 3, and the pH of the acid may be about 5. In some embodiments, the pH of the residual electroplating solution may be about 3.5, and the pH of the acid may be about 3.5 to 4.5. In some embodiments, the pH of the residual electroplating solution may be about 4, and the pH of the acid may be about 4. In some embodiments, the pH of the electroplating solution may be below 1, and the pH of the acid may be about 2 for the purpose of reducing cross-contamination. In some embodiments, the pH of the acid may be equal or similar to the pH of the electroplating solution. In some embodiments, the acid may be selected from hydrogen bromide (BrH), hydrogen iodide (HI), hydrochloric acid (HCl), nitric acid (HNO₃), nitrous acid (HNO₂), phosphoric acid (H₃PO₄), sulfuric acid (H₂SO₄), boric acid (H₃BO₃), hydrofluoric acid (HF), hydrobromic acid (HBr), perchloric acid (HClO₄), hydroiodic acid (HI), and combinations thereof. In some embodiments, the acid is an acid solution comprising carbonic acid (H₂CO₃). In some embodiments, carbonic acid is applied as an acid, wherein the pH of the acid is similar or somewhat higher than the pH of the electroplating solution or electrolyte. In some embodiments, a carbonic acid rinse agent is formed by dissolving carbon dioxide in water and under pressure to achieve a pH between about 3 and 4. In some embodiments, carbon dioxide may also be injected directly in water to form carbonic acid or may be pressurized on one side of a permeable membrane with water on the other side of the membrane.

In block 715, the rinsate is removed from the wafer, with any of the methods described herein.

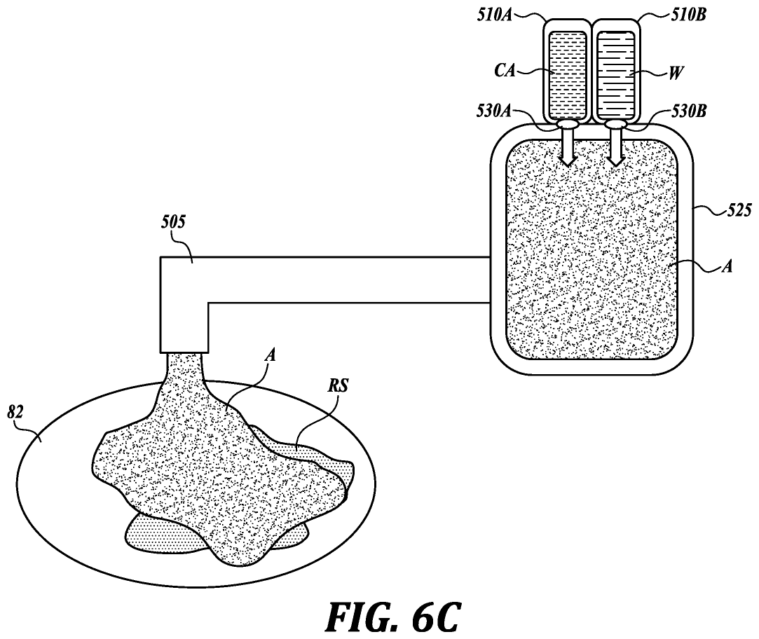

FIG. 8 is another method of reducing cross-contamination of a wafer, in accordance with the present technology. It should be understood that method 800 may be carried out with any of the systems disclosed herein. In some embodiments, method 800 may include an electroplating processor (such as electroplating processor 50), electroplating solution (such as electroplating solution ES), a wafer (such as wafer 100), a seal (such as seal 46), residual electroplating solution (such as residual electroplating solution RS), an acid (such as acid A), and/or a rinsate (such as rinsate R). In some embodiments, the method 800 may further be carried out by any of the mixing systems disclosed and illustrated in FIGS. 6A-6C.

In block 805, the wafer (or seal) is removed from the electroplating solution. In some embodiments, when the wafer is removed from the electroplating solution, residual electroplating solution (such as shown in FIG. 5A) is present on the wafer.

In block 810, the acid is mixed. As described herein, in some embodiments, the acid is mixed by directing acid precursor and water down a rinse line of a sufficient length to form a homogenous acid. In some embodiments, the acid is mixed with a static mixer. In yet other embodiments, the acid may be mixed by injection mixing.

In block 815, the wafer (or seal) is rinsed with acid. In some embodiments, the acid mixes with the residual electroplating solution to form a rinsate. The acid may be any of the acids described herein. In some embodiments, as disclosed herein, the residual electroplating solution and the acid may have similar pH to one another.

In block 815, the rinsate is removed from the wafer, with any of the methods described herein.

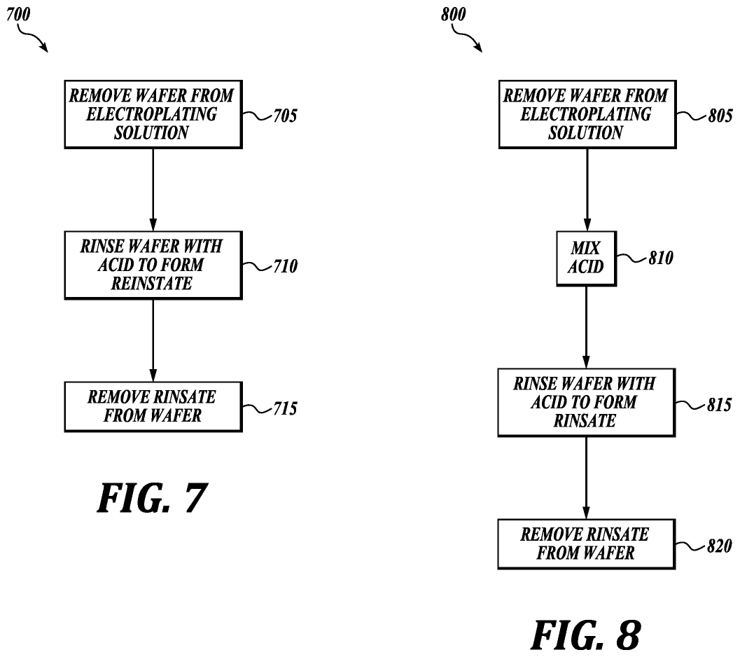

FIG. 9 is another method of reducing cross-contamination of a wafer, in accordance with the present technology. It should be understood that method 700 may be carried out with any of the systems disclosed herein. In some embodiments, method 700 may include an electroplating processor (such as electroplating processor 50), electroplating solution (such as electroplating solution ES), a wafer (such as wafer 100), a seal (such as seal 46), residual electroplating solution (such as residual electroplating solution RS), an acid (such as acid A), and/or a rinsate (such as rinsate R).

In block 905, the wafer (or seal) is rinsed with MSA. In some embodiments, the wafer or seal may be removed from the electroplating solution. In some embodiments, methane sulfonic acid (MSA) is a suitable acid in accordance with the present disclosure. In some embodiments, the acid comprises or consists of methane sulfonic acid. For example, methane sulfonic acid (pH of about 2 and a concentration of approximately 20 g/L methane sulfonic acid (MSA) in water) may be provided in an amount sufficient to prevent the formation of a precursor layer and/or subsequent plate-up. In one embodiment, methane sulfonic acid is a suitable acid for use in accordance with the present disclosure, wherein the methane sulfonic acid has a concentration of at least 3.6 g/L and solution thereof has a pH of about 3. In some embodiments, the acid such as methane sulfonic acid (MSA) is contacted with a surface in need thereof for 10 seconds or more, or a duration sufficient to displace the bulk of the plating chemistry from the surface being cleaned.

In block 910, the rinsate is removed from the wafer, with any of the methods described herein.

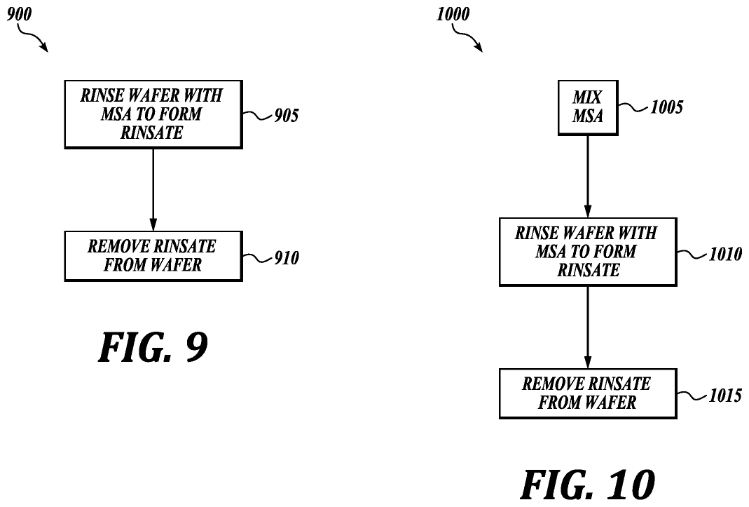

FIG. 10 is a method 1000 of reducing cross-contamination of a wafer, in accordance with the present technology. It should be understood that method 1000 may be carried out with any of the systems disclosed herein. In some embodiments, method 1000 may include an electroplating processor (such as electroplating processor 50), electroplating solution (such as electroplating solution ES), a wafer (such as wafer 100), a seal (such as seal 46), residual electroplating solution (such as residual electroplating solution RS), an acid (such as acid A), and/or a rinsate (such as rinsate R). In some embodiments, the method 800 may further be carried out by any of the mixing systems disclosed and illustrated in FIGS. 6A-6C.

In block 905, the wafer (or seal) is rinsed with MSA. In some embodiments, MSA may include 1M MSA, and may be diluted in water 50:1. In some embodiments suitable methane sulfonic acid for use herein includes methane sulfonic acid having a molar concentration in the range of 0.02 M to 1M and a pH in the range of 2 to 4.5. In some embodiments, for example where the electroplating solution includes a tin-silver plating bath with a pH of around 3, a 0.04M solution of MSA with a pH of about 3.5 is sufficient to preventing plate-up after several thousand plating cycles e.g., greater than 2500 plating cycles. As described herein, in some embodiments, the MSA is mixed by directing acid precursor and water down a rinse line of a sufficient length to form a homogenous MSA mixture. In some embodiments, the MSA is mixed with a static mixer. In yet other embodiments, the MSA may be mixed by injection mixing.

In block 1015, the rinsate is removed from the wafer, with any of the methods described herein.

It should be understood that all methods 700, 800, 900, 1000 should be interpreted as merely representative. In some embodiments, process blocks of all methods 700, 800, 900, 1000 may be performed simultaneously, sequentially, in a different order, or even omitted, without departing from the scope of this disclosure.

### Example

In one example, MSA was prepared according to Table 1.

TABLE 1
Example MSA acids

| MSA (g/L) | pH |
|---|---|
| 0 | 5 |
| 0.0625 | 3.24 |
| 0.125 | 2.94 |
| 0.25 | 2.59 |
| 0.5 | 2.39 |
| 1 | 2.22 |
| 2 | 1.89 |
| 4 | 1.66 |
| 8 | 1.19 |
| 16 | 1.03 |
| 32 | 0.93 |

As shown in Table 1, as the concentration of MSA in grams per liters was increased, the pH of the acid was lowered. Any of the MSA concentrations shown in Table 1 could be used to perform the processes described herein. Further, any of the MSA acids shown in Table 1 could be mixed with the systems shown and described in FIGS. 6A-6C.

While illustrative embodiments have been illustrated and described, it will be appreciated that various changes can be made therein without departing from the spirit and scope of the invention.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

We claim:

1. A method of reducing cross-contamination on a wafer, the method comprising:
removing the wafer from an electroplating solution;
rinsing the wafer with an acid, wherein the acid contacts a residual electroplating solution on the wafer and forms a rinsate; and
removing the rinsate from the wafer.

2. The method of claim 1, wherein the acid has a pH ranging from about 0 to about 5.5.

3. The method of claim 1, wherein the acid has a pH of 4 or lower.

4. The method of claim 1, wherein the acid has a pH of 2 or lower.

5. The method of claim 1, wherein the acid comprises carbonic acid.

6. The method of claim 1, wherein the acid comprises methane sulfonic acid (MSA).

7. The method of claim 1, wherein the method further comprises:
mixing acid precursors before rinsing the wafer.

8. The method of claim 7, wherein mixing the acid comprises:
using a static mixer to mix the acid precursors in a separate container.

9. The method of claim 7, wherein mixing the acid comprises:
directing the acid precursors through a rinse line of a length sufficient to mix the acid precursors into a homogenous acid.

10. The method of claim 7, wherein mixing the acid precursors comprises:
injection mixing the acid precursors.

11. The method of claim 1, wherein the acid is applied under conditions sufficient to prevent precipitation of organometallic or metallic precursors.

12. A method of removing cross-contamination on a wafer, the method comprising:
rinsing the wafer with a methane sulfonic acid (MSA) mixture, wherein the MSA mixture contacts residual electroplating solution on the wafer and forms a rinsate; and
removing the rinsate from the wafer.

13. The method of claim 12, wherein the method further comprises:
mixing the MSA mixture before rinsing the wafer.

14. The method of claim 12, wherein mixing the MSA comprises:
using a static mixer to mix the MSA mixture in a separate container.

15. The method of claim 12, wherein mixing the MSA mixture comprises:
directing the MSA mixture through a rinse line of a length sufficient to mix the acid into a homogenous mixture.

16. The method of claim 12, wherein mixing the MSA mixture comprises:
injection mixing the MSA mixture.

17. The method of claim 12, wherein the MSA mixture is applied under conditions sufficient to prevent precipitation of organometallic or metallic precursors.

18. The method of claim 12, wherein the MSA mixture has a pH ranging from about 0 to about 5.5.

19. The method of claim 12, wherein the MSA mixture has a pH of 4 or lower.

20. The method of claim 1, wherein the MSA mixture has a pH of 2 or lower.
